(19) United States
(12) Patent Application Publication
(10) Pub. No.: US 2003/0203282 A1
(43) Pub. Date: Oct. 30, 2003

(54) Nano-metal electrode rechargeable battery cell

(76) Inventors: Sylvie Grugeon, Feuquieres (FR); Stephanne Laruelle, Saveuse (FR); Philippe Poizot, Ormoy Le Davien (FR); Jean-Marie Tarascon, Amiens Cedex (FR)

Correspondence Address: David A. Hey, Esq., Telcordia Technologies, Inc., 445 South Street, 1G112R, Morristown, NJ, 07960, US

(21) Appl. No.: 10/134,953

(22) Filed: Apr. 29, 2002

(51) Int. Cl. H01M 4/40; H01M 4/58

(52) U.S. Cl. 429/231.95; 429/220; 429/221; 429/223; 429/224

(57) ABSTRACT

A rechargeable lithium battery cell comprises an electrode member comprising a nano-particle transition metal, Co, Cu, Fe, Ni, or Mn having particle size less than about 200 nanometres, which participates with lithium from a complementary electrode source and dissociated electrolyte anions in a reversible redox reaction providing substantial battery cell capacities which improve with continued operation of the cell.

### BACKGROUND OF THE INVENTION

The present invention relates generally to rechargeable electrochemical energy storage cells such as may be employed as secondary batteries. Such cells have typically comprised a negative electrode providing a source of mobile ions, e.g., for highly preferred Li⁺ ions, lithium metal or lithium alloys, or Li⁺-containing insertion or intercalation materials. Complementary positive electrodes in such cells have commonly comprised similar alloying, insertion, or intercalation materials which enable the charge/discharge cycling interchange of mobile Li⁺ ions between the electrodes via an electrolyte medium bridging an electron-insulative, ion-transmissive separator member interposed between the electrode members.

More particularly, the present invention provides in such rechargeable cells a novel electrode element which engenders a new and highly effective rechargeable cell mechanism leading to improved cell charge capacity and recycling stability. Whereas prior cells relied significantly upon the open structure of active electrode materials to enable the reversible insertion of cycling ions, the active materials of the present cell electrodes, exhibiting no similar structure, apparently support a contingent redox activity which generates the remarkable observed recycling capabilities.

### SUMMARY OF THE INVENTION

The rechargeable cells of the present invention do not rely upon the open, interstitial structure electrode materials broadly employed in prior systems. Rather, the present cells utilize a structure in which one of the electrode pair, e.g., the complementary positive electrode in a lithium-ion cell, comprises nano-sized metal particles, i.e., having a diameter ranging up to about 200 μm, preferably in the order of about 20 to 100 nm. For this purpose, the transition metals, Co, Cu, Ni, Fe, and Mn, are particularly suitable.

As in previous battery cells, e.g., a Li-ion cell, an electrolyte composition provides a medium of mobility for exchange of active ions between the electrode members of the present cell. In a present lithium battery cell this electrolyte composition is in similar manner essentially a solution of dissociable lithium compound, preferably in a non-aqueous solvent. Any of the prior electrolyte compositions comprising solutes of LiClO₄, LiBF₄, LiCF₃SO₃, or the like in solvents comprising propylene carbonate, dimethyl carbonate, ethylene carbonate, or the like and mixtures thereof serve well in the present cells. A particularly preferred electrolyte comprises 1M LiPF₆ in an equipart mixture of propylene carbonate and ethylene carbonate.

Fabrication of the present cells may follow in large part that of prior lithium cell structures, utilizing, for instance, either metallic lithium or, preferably, lithium alloy or lithiated inclusion materials as a source of Li⁺ ions. Such fabrication is likewise similar in major respect with that of earlier cells wherein electrode members were often formed as layers of active particulate components, such as lithiated insertion or intercalation compounds, dispersed in binder media typically comprising vinyl or vinylidene polymer or copolymer materials. A (poly)vinylidene fluoride copolymer widely used in prior compositions, for example, is well-suited for cells of the present invention.

As an essential departure from prior rechargeable cells, however, the present cells comprise electrodes of nano-metal particles which exhibit no open interstices or other readily discernible means for enabling intercalation or other inclusion of transient Li⁺ ions. Nonetheless, apparently by virtue of the high reactivity arising from their ultra-fine particle size, these nano-metal electrode components seem to be capable of initiating a reversible dissociative reaction within the cell electrolyte composition which supports effective energy storage and delivery.

This reaction appears to generate in the electrolyte medium free radical species active in a charge transfer process forming temporarily stable associations with influent mobile Li⁺ ions during electrical discharge of the cell. An oxidative activity appears subsequently upon cell recharging to be supported by the nano-metal component with a resulting regeneration of the free radical species, thereby preventing the irreversible formation of more stable Li⁺-assimilating radical anions which could inevitably lead to permanent loss of cell capacity.

An additional advantage appears to derive from the nano-metal electrode structure of the present cells in that the repetitive high-energy involvement of the nano-particles in the cycling reactions leads to further reduction in metal particle size as a result of an electrochemical milling phenomenon with a resulting increase in electrode activity and a notable expansion of cell capacity.

### BRIEF DESCRIPTION OF THE DRAWING

The present invention will be described with reference to the accompanying drawing of which:

FIG. 1 is a diagrammatic representation in cross section of a battery cell embodying the present invention;

FIG. 2 is a graph tracing the characteristic profile of recycling voltage and specific capacity over a cycling period of about 300 cycles in a cell embodying the present invention;

FIG. 3 is a graph plotting the variation in specific capacity over the extended cycling period in the cell embodiment of FIG. 2 and;

FIG. 4 is a graph plotting the variation in specific capacity over a further extended cycling period in another cell embodiment of the present invention.

### DESCRIPTION OF THE INVENTION

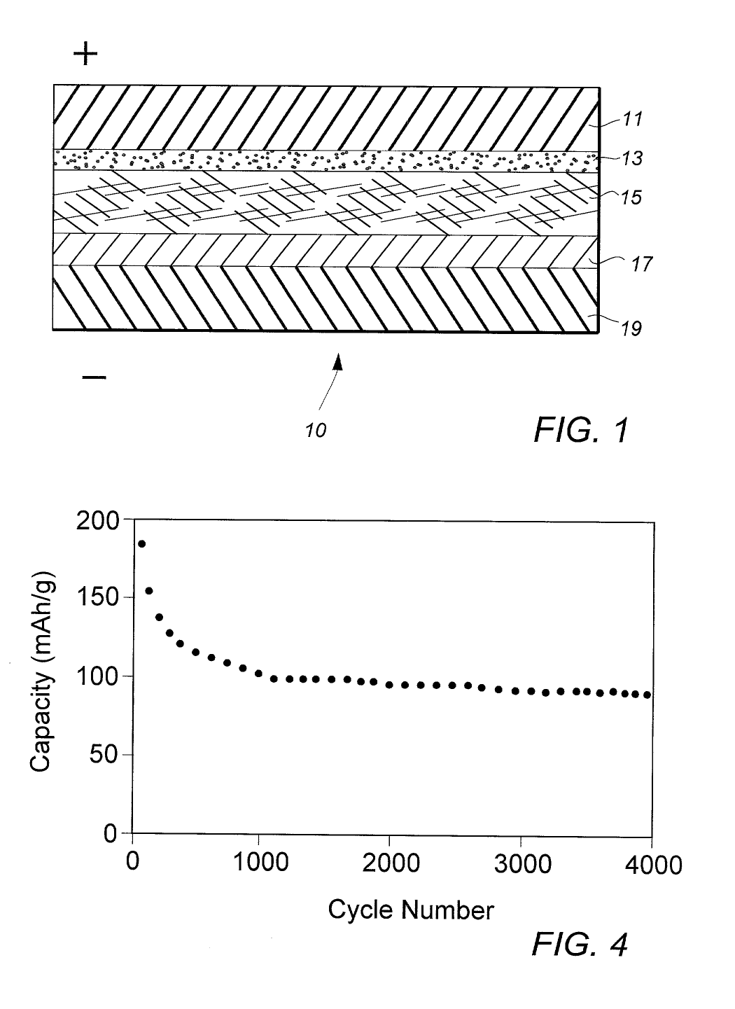

As seen in FIG. 1, a battery cell structure 10 embodying the present invention, either in the form of a familiar “button” battery or of a laminated assembly of members such as described in U.S. Pat. No. 5,460,904, essentially comprises a positive electrode member 13, a negative electrode member 17, and an interposed separator member 15 containing cell electrolyte. Current collector members 11, 19 associated with the respective complementary positive and negative electrode members provide sites for stable electrical circuit connections for the cell.

For laboratory test purposes, it has been convenient to assemble cell members in a commonly used Swagelok apparatus in which positive and negative electrode members with intervening electrolyte-saturated separator member are compressed between opposing current collector members to achieve the essential intermember contiguity. After assembly, test cells are arranged in circuit with an automatic cycling control/data-recording system, e.g., a MacPile apparatus, operating in the galvanostatic mode at a preselected cycling rate, e.g., a C rate (one cycle per hour) between 3.0 V and 0.02 V, to obtain recycling data which are plotted to yield a characteristic voltage/capacity profile of performance by the test cell.

### EXAMPLE I

Although some nano-sized particulate metals are commercially available from certain sources, in the interest of property and size control, stocks of such materials were prepared in the laboratory for use in fabricating test cells embodying the present invention. In one such procedure for the preparation of nano-particle cobalt, 50 mg cobalt nitrate was dispersed in 75 ml ethylene glycol, and 200 mg (poly)vinylpyrrolidone (PVP) and 1 ml hydrazine were added. The resulting mixture was heated under argon at the rate of about 5°/min to 140° C. at which it was maintained for about one hour prior to cooling at ambient room conditions. The reaction product was then dispersed in acetone, centrifuged, and dried to obtain cobalt particles in the nano-range of about 20 to 150 nm. Variations in reactant proportions and reaction temperatures may be utilized to provide materials of varying size and surface area.

A measure of the prepared nano-cobalt material was mixed with about 5% by weight (poly)vinylidene fluoride (PVdF) binder, and sufficient N-methyl pyrrolidone (NMP) solvent was admixed to form a viscous paste. The resulting composition was applied to a copper collector element at about 1 mg Co/cm². After air-drying at about 100° C. the combination provided a positive electrode member 13 of particulate Co composition coated on a stainless steel collector member 11, as depicted in FIG. 1.

A lithium foil backed with a stainless steel element was inserted into a standard Swagelok test cell (not shown) to form the combination of Li negative electrode member 17 and steel collector member 19, similarly depicted. A sheet of glass paper saturated with a 1 M solution of LiPF₆ in a 1:1 mixture of ethylene carbonate (EC) and dimethyl carbonate (DMC) to form separator member 15 was arranged upon negative electrode member 17, and the positive electrode combination was positioned to complete the cell arrangement as shown in FIG. 1.

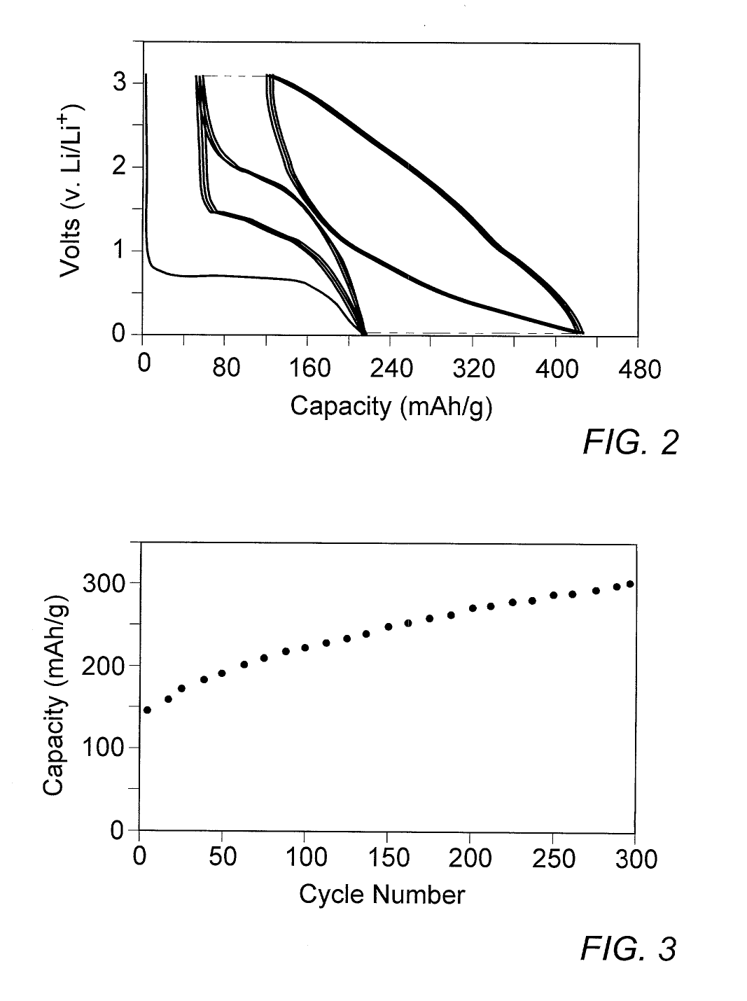

The electrode/separator assembly was compressed within the Swagelok apparatus in the usual manner and the resulting cell was connected in circuit with a typical automatic cycling control/data-recording system for testing over a preselected series of charge/discharge cycles at room temperature. The performance graph of FIG. 2 depicts the initial portion of the data collected in such a test. Additional data collected during a protracted test period and depicted in FIG. 3 show the extraordinary increase in specific capacity of the cell during the test period, a result which runs contrary to most rechargeable cells of prior art conformation.

### EXAMPLE II

In a variant process, nano-sized cobalt particle electrode material was prepared by annealing reduction of 150 nm CoO powder in an atmosphere of hydrogen at about 700° C. for about 15 hours. The resulting Co nano-particles of about 50 to 200 nm were dispersed in about 5% PVdF binder in NMP solvent and applied to a Ni collector element at about 1 mg Co/cm² to form, after drying, a positive electrode layer 13. The resulting positive electrode/collector member was then assembled with separator/electrolyte and negative electrode members prepared as in Ex. I to obtain a cell for testing. Cycling the cell between 0 V and 3 V at about 55° C. provided data indicating stable specific capacity of about 400 mAh/g after about 100 cycles.

### EXAMPLE III

Nano-particle Ni was prepared from nickel nitrate in the manner of Ex. I and a test cell was constructed as described in that example. A cycling test conducted with the cell in like manner provided substantially similar results.

### EXAMPLE IV

Nano-particle Fe was prepared from FeO in the manner of Ex. II and a test cell was constructed as described in that example. A cycling test conducted with the cell in like manner provided substantially similar results.

### EXAMPLE V

Nano-particle Co prepared in Ex. I was used to prepare a similar test cell comprising as a variant a 1 M solution of LiPF₆ in ethylene carbonate (EC) as the electrolyte. The cell was cycled between 0 V and 1.8 V over an unprecedented period of about 4000 cycles, yet continued to exhibit a remarkably stable capacity of about 100 mAh/g, as depicted by the resulting test data plotted in FIG. 4.

It is anticipated that other embodiments and variations of the present invention will become readily apparent to the skilled artisan in the light of the foregoing description and examples, and such embodiments and variations are intended to likewise be included within the scope of the invention as set out in the appended claims.

What is claimed is:

1. A rechargeable Li battery cell comprising a pair of electrode members of complementary polarity, and a separator member interposed therebetween providing an electrolyte
characterized in that
one of said electrode members provides a source of Li⁺ ions and the complementary electrode member comprises an active component consisting essentially of nano-particle transition metal having a particle size range below about 200 nanometres.

2. A battery cell according to claim 1 wherein said complementary electrode active component comprises a metal selected from the group consisting of Co, Cu, Fe, Ni, and Mn.

3. A battery cell according to claim 2 wherein said active component comprises the positive electrode of said cell.

4. A battery cell according to claim 3 wherein the active component of said positive electrode consists essentially of Co nano-particles in the range of 30 nm to 150 nm.

5. A battery cell according to claim 3 wherein the negative electrode comprises metallic lithium or a lithium alloy.
